(19) United States
(12) Patent Application Publication
(10) Pub. No.: US 2015/0099537 A1
(43) Pub. Date: Apr. 9, 2015

(54) SKI AREA INCIDENT REPORTING AND INCIDENT RESPONSE SYSTEM

(71) Applicant: AMERICAN WOODDUCK LLC, Sandpoint, ID (US)

(72) Inventor: Gregg Merithew, Sandpoint, ID (US)

(21) Appl. No.: 14/507,675

(22) Filed: Oct. 6, 2014

Related U.S. Application Data
(60) Provisional application No. 61/887,393, filed on Oct. 6, 2013.

(51) Int. Cl. H04W 4/00; H04W 4/02

(52) U.S. Cl. CPC H04W 4/005; H04W 4/021
USPC 455/456.1

(57) ABSTRACT

The techniques described herein identify and/or verify that devices of snow riders and patrol members are located within a pre-defined geo-fence. In response, one or more functions of an application may be enabled that allow the devices to communicate with each other and/or locate each other.

### PRIORITY APPLICATION

This application claims the benefit of U.S. Provisional Application No. 61/887,393, filed Oct. 6, 2013, the entire contents of which are incorporated herein by reference.

### BACKGROUND

There are many types of incidents within ski area boundaries that may require the assistance or attention of a ski resort's professional patrol staff. For example, injury accidents, theft, unsafe trail conditions or general aid are just a few examples of the kinds of incidents that may need to be brought to the attention of the professional patrol staff. Two-way radios are currently the primary communication of choice for on-mountain professional patrol staff. However, these two-way radios do not provide a means for the professional patrol staff to communicate with visiting snow riders (e.g., skiers, snowboarders, etc.), or for the professional patrol staff to locate a visiting snow rider, e.g., in an event of an injury.

### SUMMARY

The techniques described herein provide a reporting and incident response system that utilizes an application that runs on a device. A device's automatic locating functionality (e.g., global positioning system (GPS), triangulation, internet protocol (IP) address mapping, etc.) may be used along with a pre-defined geo-fence, e.g., that defines a ski area boundary, to qualify the professional patrol staff and visiting snow riders. For instance to qualify the professional patrol staff and the visiting snow riders, the techniques may verify that a member of the professional patrol staff and a visiting snow rider are located within a pre-defined geo-fence. Upon qualification, the application may enable communication functionality between the patrol staff member and a visiting snow rider.

Accordingly, the techniques described herein identify devices of snow riders and patrol members that are located within a pre-defined geo-fence. In response to the identification, one or more functions of an application may be enabled that allow the devices to communicate with each other and/or locate each other.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, algorithms, components, modules, and/or technique(s) as permitted by the context above and throughout the document.

### BRIEF DESCRIPTION OF THE CONTENTS

The detailed description is presented with reference to accompanying figures. In the figures, the left-most digit(s) of a reference number identifies the figure in which the reference number first appears. The use of the same reference numbers in different figures indicates similar or identical items.

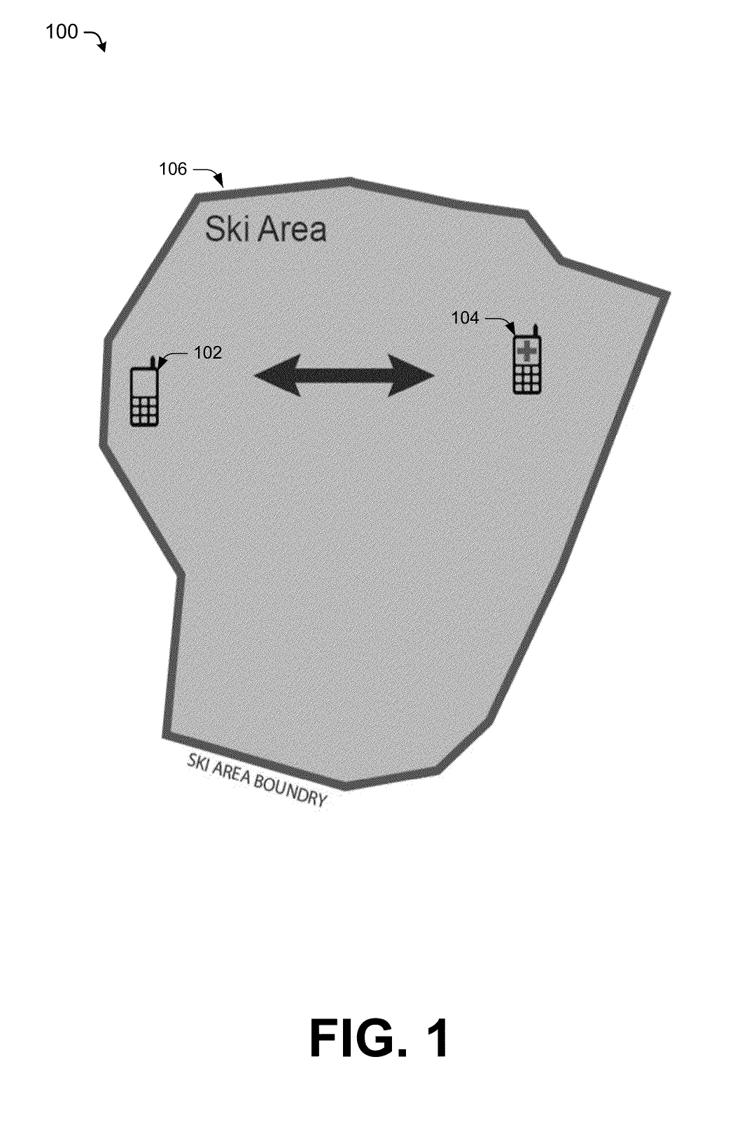

FIG. 1 illustrates an example environment in which devices of a professional patrol staff member and a snow rider may be qualified as being located within a geo-fence, and therefore, an application enables communications between the snow rider and professional patrol staff member.

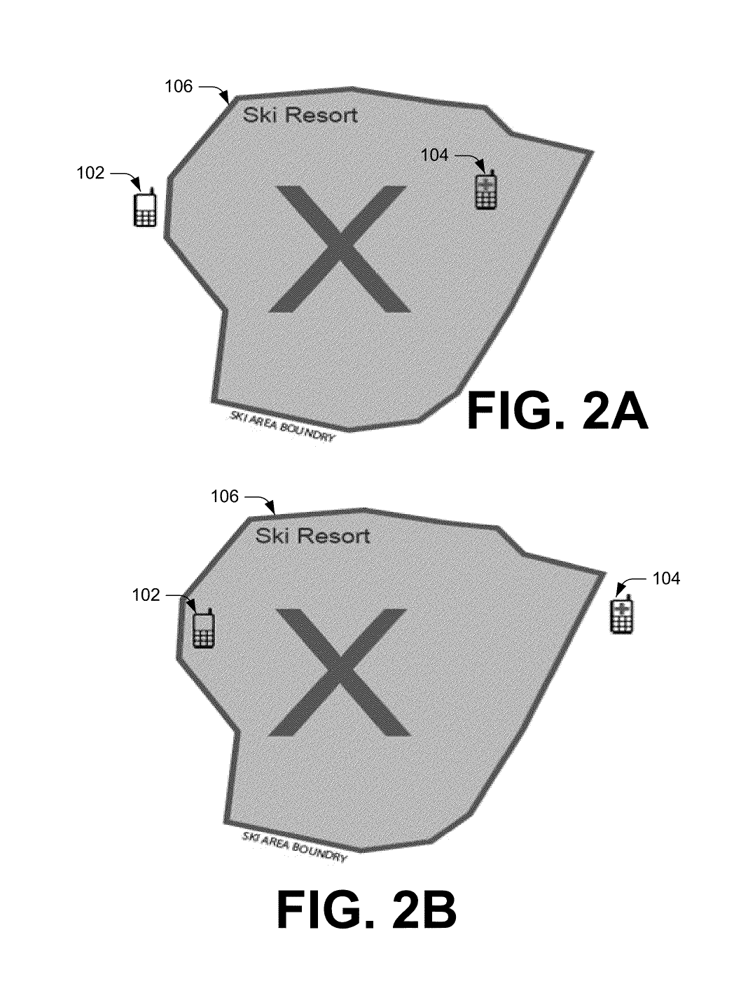

FIGS. 2A and 2B illustrate example environments in which functionality of the application may not be enabled because either the device of the snow rider or the device of professional patrol staff member is located outside the geo-fence.

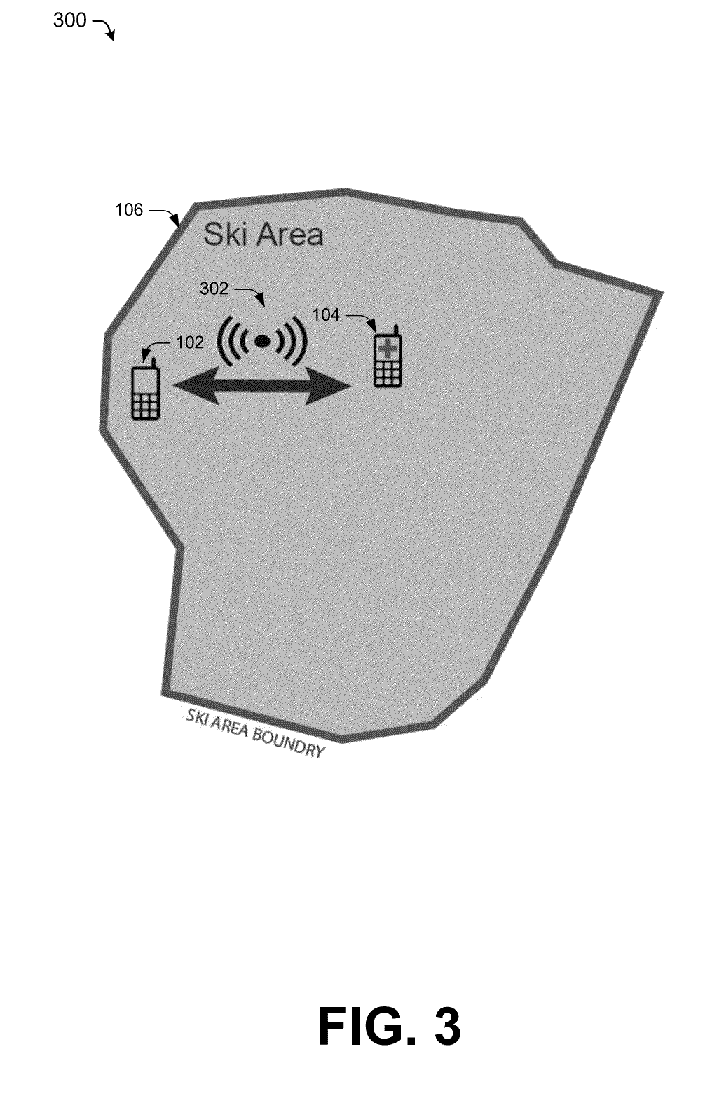

FIG. 3 illustrates an example environment in which a locator function of the application may use a proximity detector to guide a professional patrol staff member to a snow rider.

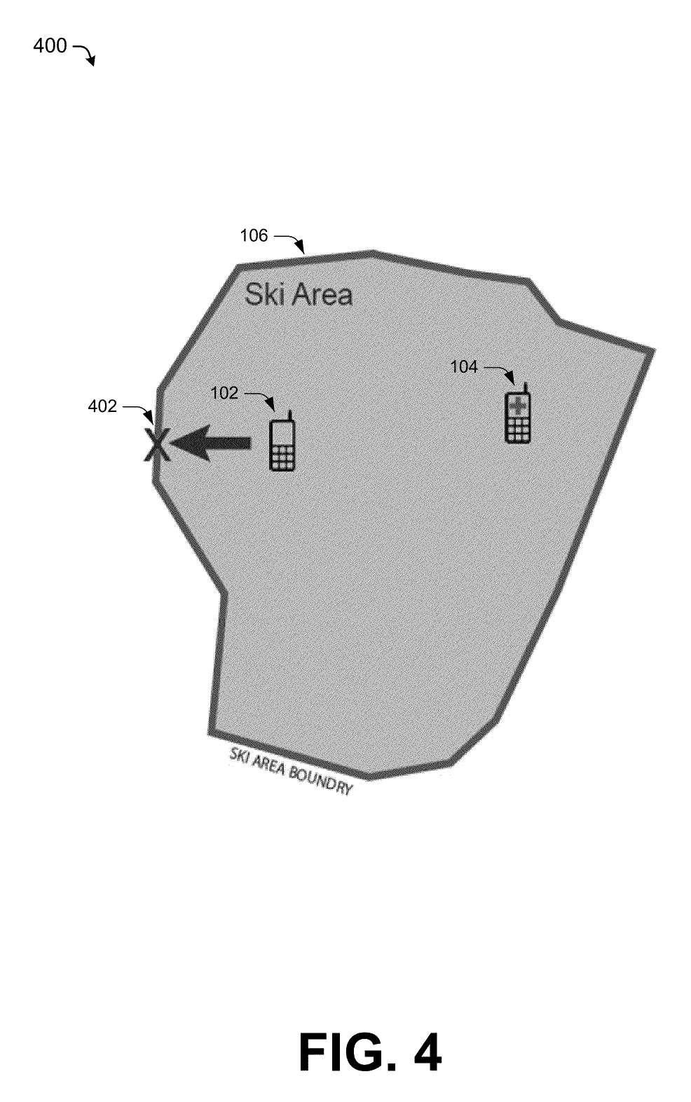

FIG. 4 illustrates an example environment in which a location and/or a time that a device of a snow rider leaves the geo-fence may be recorded and used to help search for the snow rider.

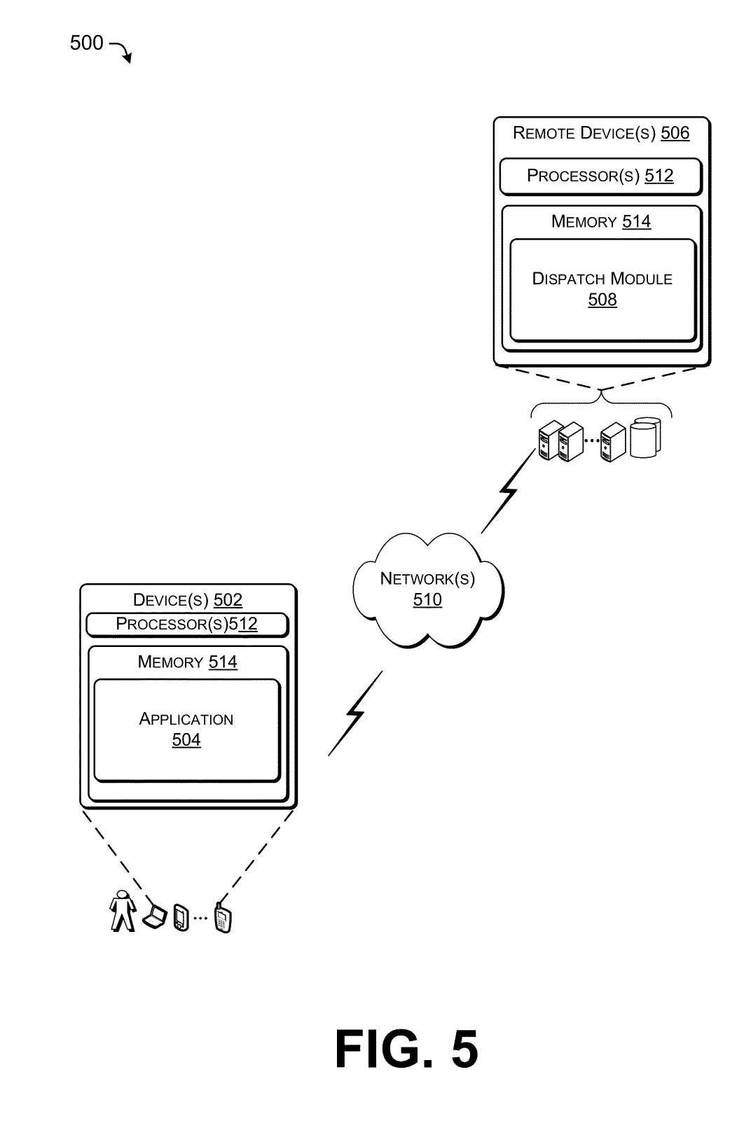

FIG. 5 illustrates an example computing environment that is usable to implement the techniques described herein.

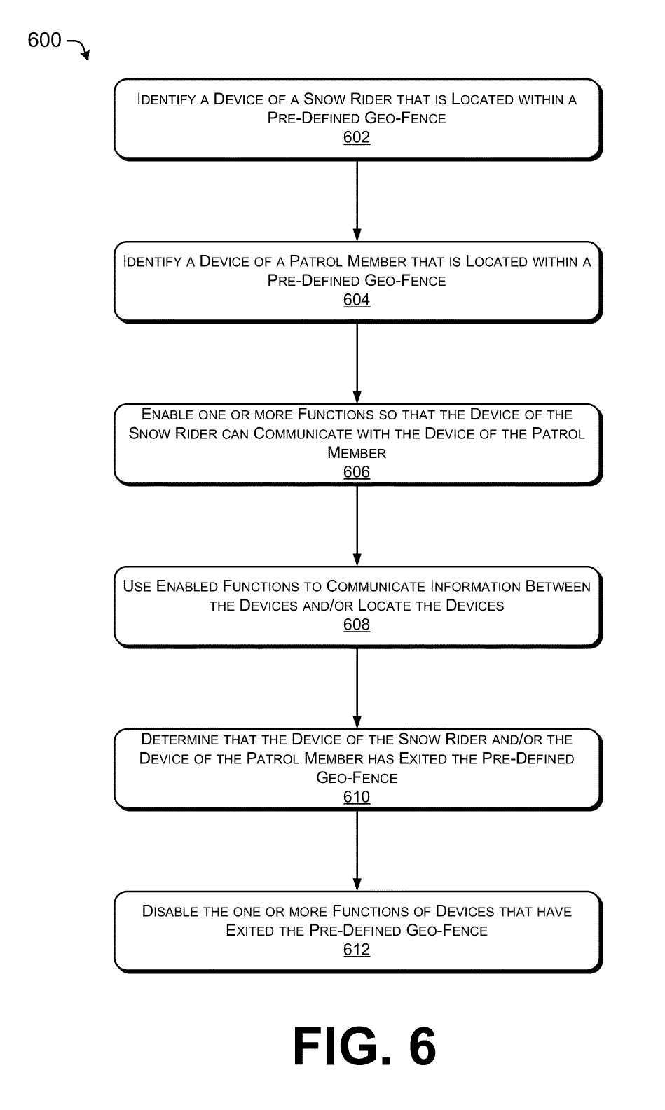

FIG. 6 illustrates an example process that qualifies a device of a snow rider and a device of a patrol member so that communication functions can be enabled.

### DETAILED DESCRIPTION

The techniques described herein may provide a reporting and incident response system and may be implemented via a device application that can be downloaded and installed on devices of professional patrol staff members and/or visiting snow riders. In various examples, the techniques may geographically qualify professional patrol staff members and snow riders by utilizing a geo-fence configured around the ski area (e.g., the geo-fence may reflect the ski area boundary). For instance, to qualify professional patrol staff members and snow riders, the techniques may identify and verify that the devices are located inside the same geo-fence so that the functionality of the application can be enabled.

In various examples, a version of the application configured for installation on a professional patrol member's device may incorporate capabilities to receive a dispatch notification sent to one or more professional patrol members. Once enabled, the application may provide the snow rider with options to report incidents (e.g., an injury) directly to a patrol dispatch system so that professional patrol members within the same geo-fence can be identified and/or located. Upon receiving an indication of an incident report and via the use of their respective devices, a professional patrol member may communicate directly with the visiting snow rider and/or locate the visiting snow rider.

Therefore, in various examples, the application creates a link between a professional patrol staff member and a visiting snow rider by qualifying the geographic location of devices within the ski area boundaries utilizing a pre-defined geo-fence. A geo-fence may create a virtual perimeter around a real-world geographic area (e.g., a resort ski area).

FIG. 1 illustrates an example environment 100 where devices of a professional patrol member and a snow rider are qualified as being at a location within a geo-fence, and therefore, an application enables communications between the snow rider and the professional patrol member. For instance, FIG. 1 shows a first device 102 associated with a snow rider and a second device 104 associated with a professional patrol member. Both the devices 102 and 104 may be qualified as being within a pre-defined geo-fence 106 (e.g., a ski area boundary), and therefore, functionality of the application may be enabled. In various examples, the devices 102 and/or 104 may be qualified at a time when the device enters, or crosses into, the predefined geo-fence 106.

In various examples, communication functions (e.g., patrol dispatch) and/or other functions implemented by the application may only be enabled if a device (e.g., 102 or 104) is located within the ski are boundary. FIGS. 2A and 2B illustrate example environments where functionality of the application may not be enabled because either the device 102 of the snow rider or the device of professional patrol member 104 is located outside of the pre-defined geo-fence 106. For example, the application or individual application functions may automatically be disabled if the device 102 of the snow rider or the device 104 of the professional patrol member exits the pre-defined geo-fence.

FIG. 3 illustrates an example environment 300 in which a locator function of the application may use a proximity detector to guide a professional patrol member to a snow rider, e.g., after an incident report has been received. As discussed above, a snow rider may use a device 102 to report an incident (e.g., an injury). The locator function may be used as part of a patrol dispatch feature of the application. For example, an available patrol member may be identified and dispatched to respond to the incident. Using location information of the device 102 of the snow rider and of the device 104 of the professional patrol member, the locator function may emit a signal 302 (e.g., an audible signal, a vibrating signal, etc.) on one or more of device 102 or device 104, the signal indicating a proximity of the two devices. Therefore, the snow rider and/or the professional patrol member are provided with a proximity indication (e.g., that professional assistance is close). The signal indicating proximity may vary in frequency and/or strength thereby guiding the professional patrol member to the snow rider needing assistance.

In various examples, once the responding professional patrol member reaches a pre-determined distance from the snow rider needing assistance, the locator function based on proximity may automatically record a time and/or cease emitting the signal 302. Moreover, the responding professional patrol member may indicate, via the application on the device 104, that the dispatch to help has been completed. For example, the professional patrol member may package a patient (e.g., a snow rider) and transport the patient down the ski hill to an aid area, and once the patient has been released, the responding professional patrol member may indicate, via the application on the device 104, that the dispatch to help has been completed.

In various examples, the application described herein allows any qualified (e.g., a device verified to be located within a pre-defined geo-fence) snow rider to directly contact professional patrol staff if assistance is needed. In the event of an injury incident, the snow rider can use the application executing on the device 102 to send an incident message to a dispatch system. In one example, the dispatch system may be configured with a central dispatching interface that handles incoming incident messages. Upon receiving the incident message reporting an injury, for example, the dispatching system may send (e.g., push out) an incident notification message to the devices of professional patrol members qualified to be located within the pre-defined geo-fence. The incident notification message may include a location of the incident (e.g., based on a location of device 102), a name of the snow rider needing assistance, and/or a call back telephone number. This information may be displayed to the individual professional patrol members so that at least one professional patrol member can respond to the incident. Moreover, in some examples, the location of other qualified and available professional patrol members may be communicated and/or displayed to the devices of the professional patrol members to that the responding professional patrol member can determine that he or she is the closest one to the incident or in the best position to respond to the incident.

In another example, the dispatch system may be configured so that individual professional patrol members (e.g., all patrol members within the ski area boundary) receive the incident message from which one or more patrol members can respond to the incident message and/or inform other patrol members that a response is being carried out.

In addition to injury incidents, the application may also allow a qualified snow rider to report other types of incidents such as an unsafe terrain condition incident, a vandalism of property incident (e.g., chair lift vandalism), a theft incident (e.g., theft of ski equipment), and/or a missing person incident. In various examples, a variable urgency level based on a type of incident may be selected and communicated by the device 102 of the snow rider or may be assigned to an incident message by the dispatch system. For example, an injury incident may be more urgent than a vandalism incident and may need to be responded to immediately (e.g., before the vandalism incident is responded to).

Accordingly, a visiting and qualified snow rider may report different types of incidents to the dispatch system. The dispatching system may then push out an incident notification message to the devices of qualified professional patrol members. An individual incident report may include a location of a reporting device (e.g., 102) at the time of submission, an identification of the reporting parting (e.g., a snow rider's user name), a call back phone number, and/or any other pertinent information that may be used to enable the communications and/or location functionality discussed above. In association with reporting the incident, a snow rider may also be able to provide an indication of an urgency level to help the patrol dispatch system prioritize incoming incidents. Moreover, the application may enable audio, video and/or photo attachments to be reported in association with an incident message.

In various examples, the application may include an exit location request function. The exit location request function may be utilized by the professional patrol staff to search for snow riders that entered the pre-defined geo-fence and then subsequently exited the pre-defined geo-fence.

FIG. 4 illustrates an example environment 400 in which a location and/or a time 402 that a device of a snow rider leaves the pre-defined geo-fence 106 may be recorded and logged so that it can be used to help search for the snow rider. For example, upon receiving a missing person incident report or if an out-of-bounds search for a snow rider is being implemented, an exit location and an exit time 402 automatically logged when the snow rider exited the pre-defined geo-fence 106 may be used by professional patrol members or ski resort officials to help search for the lost snow rider.

Accordingly, in various examples, the techniques described herein enable snow riders visiting a ski area to directly communicate with professional patrol staff members so that incidents requiring attention or assistance can be efficiently reported. Moreover, the techniques described herein allow for the creation and maintenance of a digital data trail of all incidents that have been reported and/or responded to by the professional patrol staff.

FIG. 5 illustrates an example computing environment 500 that is usable to implement the techniques described herein. The environment 500 includes one or more devices 502 (e.g., the device 102 of a snow rider or the device 104 of the professional patrol member) that individually include the application 504 described herein. The environment 500 may also include one or more remote devices 506 that may individually, and separately, include a dispatch module 508 configured to communicate with the devices 502 and implement the dispatching described above. In various examples, the one or more devices 502 may communicate with the one or more remote devices 506 via one or more networks 510 to implement the techniques described above.

The devices 502 and/or the remote devices 506 may individually include, but are not limited to, any one of a variety of devices, including portable devices or stationary devices. For instance, a device may comprise a smart phone, a mobile phone, a personal digital assistant (PDA), an electronic book device, a laptop computer, a desktop computer, a tablet computer, a portable computer, a gaming console, a personal media player device, a server computer or any other electronic device.

Therefore, a device 502 and/or a remote device 506 may individually and separately include one or more processors 512 and memory 514. The processor(s) may be a single processing unit or a number of units, each of which could include multiple different processing units. The processor(s) may include a microprocessor, a microcomputer, a microcontroller, a digital signal processor, a central processing unit (CPU), a graphics processing unit (GPU), a security processor etc. Alternatively, or in addition, some or all of the techniques described herein can be performed, at least in part, by one or more hardware logic components. For example, and without limitation, illustrative types of hardware logic components that can be used include a Field-Programmable Gate Array (FPGA), an Application-Specific Integrated Circuit (ASIC), an Application-Specific Standard Products (ASSP), a state machine, a Complex Programmable Logic Device (CPLD), other logic circuitry, a system on chip (SoC), and/or any other devices that perform operations based on instructions. Among other capabilities, the processor(s) may be configured to fetch and execute computer-readable instructions stored in the memory.

The memory may include one or a combination of computer-readable media. As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, phase change memory (PRAM), static random-access memory (SRAM), dynamic random-access memory (DRAM), other types of random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media includes computer-readable instructions, data structures, program modules, or other data in a modulated data signal, such as a carrier wave. As defined herein, computer storage media does not include communication media.

The memory 514 may include an operating system configured to manage hardware and services within and coupled to a device for the benefit of other modules, components and devices. In some embodiments, the one or more remote devices 506 may include one or more servers or other computing devices that operate within a network service (e.g., a cloud service). The network(s) 510 may include the Internet, a Mobile Telephone Network (MTN), a local area wireless technology (e.g., Wi-Fi) or other various communication technologies.

In various examples, the techniques discussed above may be implemented in hardware, software, or a combination thereof. In the context of software, operations represent computer-executable instructions stored on one or more computer-readable storage media that, when executed by one or more processors, configure a device to perform the recited operations. Generally, computer-executable instructions include routines, programs, objects, components, data structures, and the like that perform particular functions or implement particular abstract data types.

Example operations are described herein with reference to FIG. 6. The example process 600 of FIG. 6 is illustrated as a logical flow graph, which represents a sequence of operations that can be implemented in hardware, software, or a combination thereof. In the context of software, the operations represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Moreover, the example operations in FIG. 6 may be described with reference to the features and/or elements discussed above with respect to any one of FIGS. 1-5.

At operation 602, a device of a snow rider may be identified to be located within a pre-defined geo-fence. For example, the dispatch module 508 may use a device's automatic locating functionality (e.g., GPS) to determine and verify that the device is located within the pre-defined geo-fence (e.g., a ski area boundary).

At operation 604, a device of a patrol member may be identified to be located within the pre-defined geo-fence. For example, the dispatch module 508 may use a device's automatic locating functionality to determine and verify that the device is located within the pre-defined geo-fence.

At operation 606, one or more functions that permit the device of the snow rider to communicate with the device of the patrol member may be enabled.

At operation 608, the enabled functions may be used to that the device of the snow rider and the device of the patrol member can communicate. For example, a function may permit the snow rider to report an incident so that a patrol member can respond to the incident (e.g., the device of the patrol member may be used to call the device of the snow rider, the device of the patrol member may be used to locate the device of the snow rider, etc.). In another example, a function may include a locator function that emits a signal based at least in part on a proximity (e.g., distance) between the device of the snow rider and the device of the patrol member. In yet another example, a function may include a dispatch function that determines that the device of the patrol member is located in a position to respond to the incident communicated by the device of the snow rider (e.g., the closest position, a position at a top of a ski run opposed to a position at a bottom of the ski run, etc.).

At operation 610, the device of the snow rider and/or the device of the patrol member may be determined to have exited the pre-defined geo fence. In one example, the dispatch module 508 may log an exit time and an exit location in response to determining that the device of the snow rider has exited the pre-defined geo-fence. The exit time and the exit location may be used to help locate the snow rider in the event the snow rider is lost or missing.

At operation 612, the one or more functions may be disabled in response to a device exiting the pre-defined geo-fence. For example, the functions may be disabled when a snow rider goes out of bounds, leaves after a day of skiing, and/or returns to a ski condo for lunch (e.g., if the ski condo is outside the pre-defined geo-fence).

### CONCLUSION

Although the subject matter has been described in language specific to structural features and/or methodological acts, it is to be understood that the subject matter defined in the claims is not necessarily limited to the specific features or acts described above. Rather, the specific features and acts described above are described as example forms of implementing the claims.

What is claimed is:

1. A method comprising:
identifying a snow rider device that is located within a pre-defined geo-fence;
identifying a patrol member device that is located within the pre-defined geo-fence; and
in response to identifying the snow rider device and the patrol member device that are located within the pre-defined geo-fence, enabling one or more functions that permit the snow rider device to communicate with the patrol member device.

2. The method as recited in claim 1, wherein the pre-defined geo-fence is associated with a ski area boundary.

3. The method as recited in claim 1, wherein the snow rider device and the patrol member device are identified to be located within the pre-defined geo-fence via an automatic locating functionality.

4. The method as recited in claim 1, further comprising:
determining that the snow rider device has exited the pre-defined geo-fence; and
in response to determining that the snow rider device has exited the pre-defined geo-fence, automatically disabling the one or more functions.

5. The method as recited in claim 4, further comprising logging an exit time and an exit location in response to determining that the snow rider device has exited the pre-defined geo-fence.

6. The method as recited in claim 1, wherein the one or more functions comprise at least an incident reporting function enabling information associated with an incident to be communicated from the snow rider device to the patrol member device.

7. The method as recited in claim 6, wherein the incident comprises at least one of:
an injury incident;
an unsafe terrain condition incident;
a vandalism incident; or
a theft incident.

8. The method as recited in claim 6, further comprising determining a level of urgency associated with the incident.

9. The method as recited in claim 1, wherein the one or more functions comprise at least a locator function that emits a signal based at least in part on a distance between the snow rider device and the patrol member device.

10. The method as recited in claim 1, wherein the one or more functions comprise at least a dispatch function that determines that the patrol member device is located in a position to respond to an incident communicated by the snow rider device.

11. One or more computing devices comprising:
one or more processors;
one or more memories storing instructions that, when executed on the one or more processors, configure the one or more computing devices to:
verify that a snow rider device is located within a pre-defined geo-fence;
verify that a patrol member device is located within the pre-defined geo-fence; and
in response to verifying that the snow rider device and the patrol member device are located within the pre-defined geo-fence, enable one or more functions that permit the snow rider device to communicate with the patrol member device.

12. The one or more computing devices as recited in claim 11, wherein the instructions further configure the one or more computing devices to:
determine that the snow rider device has exited the pre-defined geo-fence; and
in response to determining that the snow rider device has exited the pre-defined geo-fence:
automatically disable the one or more functions; and
log an exit time and an exit location in response to determining that the snow rider device has exited the pre-defined geo-fence.

13. The one or more computing devices as recited in claim 11, wherein the one or more functions comprise at least an incident reporting function enabling information associated with an incident to be communicated from the snow rider device to the patrol member device.

14. The one or more computing devices as recited in claim 11, wherein the one or more functions comprise at least a locator function that emits a signal based at least in part on a distance between the snow rider device and the patrol member device.

15. The one or more computing devices as recited in claim 11, wherein the one or more functions comprise at least a dispatch function that determines that the patrol member device is located in a position to respond to an incident communicated by the snow rider device.

16. One or more computer storage media storing computer executable instructions that, when executed, perform operations comprising:
identifying a snow rider device that is located within a pre-defined geo-fence;
identifying a patrol member device that is located within the pre-defined geo-fence; and
in response to identifying the snow rider device and the patrol member device that are located within the pre-defined geo-fence, enabling one or more functions that permit the snow rider device to communicate with the patrol member device.

17. The one or more computer storage media as recited in claim 16, wherein the operations further comprise:
determining that the snow rider device has exited the pre-defined geo-fence; and
in response to determining that the snow rider device has exited the pre-defined geo-fence:
automatically disabling the one or more functions; and
logging an exit time and an exit location in response to determining that the snow rider device has exited the pre-defined geo-fence.

18. The one or more computer storage media as recited in claim 16, wherein the one or more functions comprise at least an incident reporting function enabling information associated with an incident to be communicated from the snow rider device to the patrol member device.

19. The one or more computer storage media as recited in claim 16, wherein the one or more functions comprise at least a locator function that emits a signal based at least in part on a distance between the snow rider device and the patrol member device.

20. The one or more computer storage media as recited in claim 16, wherein the one or more functions comprise at least a dispatch function that determines that the patrol member device is located in a position to respond to an incident communicated by the snow rider device.
